(19) United States
(12) Patent Application Publication
(10) Pub. No.: US 2005/0267239 A1
(43) Pub. Date: Dec. 1, 2005

(54) Polymer dispersions with low viscosity and method for production thereof

(75) Inventor: Markus Scherer, Lebach (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROHMAX ADDITIVES GMBH, Darmstadt (DE)

(21) Appl. No.: 10/525,529

(22) PCT Filed: Aug. 27, 2003
(86) PCT No.: PCT/EP03/09459

§ 371 Date: Feb. 24, 2005

(30) Foreign Application Priority Data
Oct. 22, 2002 (DE) 102 49 292.1

(51) Int. Cl. C08L 1/00

(52) U.S. Cl. 524/236; 524/356; 524/379; 524/385

(57) ABSTRACT

The present invention relates to a polymer dispersion having low viscosity, comprising A) at least one dispersed polyolefin, B) at least one dispersing component, C) at least one carrier medium and D) at least one compound having a dielectric constant of greater than or equal to 9.

The present invention relates to polymer dispersions having reduced viscosity, processes for the preparation and the use of these polymer dispersions.

Viscosity index improvers for motor oils are generally substantially hydrocarbon-based polymers. Typical addition levels in motor oils are about 0.5-6% by weight, depending on the thickening effect of the polymers. Particularly economical viscosity index improvers are olefin copolymers (OCP) which are predominantly composed of ethylene-[sic] and propylene, or hydrogenated copolymers (HSD) of dienes and styrene.

The excellent thickening effect of these polymer types must be viewed in the light of tedious processibility in the preparation of lubricating oil formulations. In particular, the poor solubility in the oils on which the formulations are based presents difficulties. Where solid polymers which have not been dissolved beforehand are used, there are therefore long periods of stirring in, the use of special stirrers and/or premilling units being necessary.

If concentrated polymers already predissolved in oil are used as customary commercial forms, only a 10-15% strength delivery form of the OCPs or HSDs can be realized. Higher concentrations are associated with excessively high actual viscosities of the solutions (>15 000 mm²/s at room temperature) and therefore can scarcely be handled. Particularly against this background, highly concentrated dispersions of olefin copolymers and hydrogenated diene/styrene copolymers were developed.

The dispersion technology described permits the preparation of polymer solutions having an OCP or HSD content of more than 20%, kinematic viscosities which permit convenient incorporation into lubricating oil formulations being obtained. In principle, the synthesis of such systems comprises the use of a so-called emulsifier or of a dispersing component. Customary dispersing components are, inter alia, OCP or HSD polymers onto which alkyl methacrylates or alkyl methacrylate/styrene mixtures have generally been grafted. Dispersions in which a solvent which dissolves the methacrylate component of the dispersion better and the OCP or HSD fraction more poorly is used are also known. Such a solvent together with the methacrylate fraction of the product forms the main component of the continuous phase of the dispersion. Formally, the OCP or HSD fraction is the main component of the discontinuous or disperse phase.

Inter alia, the following documents are regarded as prior art:
U.S. Pat. No. 4,149,984
EP-A-0 008 327
DE 32 07 291
DE 32 07 292

U.S. Pat. No. 4,149,984 describes a process for the preparation of lubricating oil additives by improving the compatibility between polyalkyl methacrylates, referred to below as PAMA, and polyolefins. The amount by weight of the PAMA is 50-80% by weight and that of the polyolefin is 20-50%. The total polymer content of the dispersion is 20-55%. The use of dispersing monomers, such as N-vinylpyrrolidone, for grafting is also mentioned. Before this application, it was known that methacrylates can be polymerized onto a polyolefin by grafting (DT-AS 1 235 491).

EP-A-0 008 327 protects the process for the preparation of lubricating oil additives based on a hydrogenated block copolymer of conjugated dienes and styrene, styrene and alkyl methacrylates or exclusively alkyl methacrylates being grafted onto the hydrogenated block copolymer in the first stage and an additional graft (e.g. N-vinylpyrrolidone) is built up in the second stage. The amount of the hydrogenated block copolymer, based on the total polymer content, is 5-55% by weight, that of the first graft consisting of PAMA/styrene is 49.5-85% and that of the second graft is 0.5-10%.

The document DE 32 07 291 describes processes which permit increased incorporation of olefin copolymer. The olefin copolymer content is said to be 20-65% in relation to the total weight of the dispersion. The subject of the invention is that more highly concentrated dispersions are obtained by using suitable solvents which dissolve olefin copolymers poorly and PAMA-containing components well. DE 32 07 291 is to be understood as being a process patent which describes in particular the preparation of the dispersions.

DE 32 07 292 substantially corresponds to DE 32 07 291 but should rather be understood as protecting certain copolymer compositions. These compositions are prepared by a process analogous to that described in DE 32 07 291.

The polymer dispersions described in the prior art already have a good property profile. However, particularly their viscosity is worthy of improvement. The higher the content of OCP or HSD, the higher in general is the viscosity of the dispersion. On the other hand, a high content of these polymers is desirable in order to reduce the transport costs. It should be considered here that a lower viscosity permits easier and faster mixing of the viscosity index improvers into the base oil. It was therefore intended to provide polymer dispersions which have a particularly low viscosity.

In addition, the processes for the preparation of the abovementioned polymer dispersions are relatively difficult to control, so that certain specifications can be complied with only with very great difficulty. Accordingly, it was intended to provide polymer dispersions whose viscosity can be easily adjusted to predetermined values.

A further object was to provide polymer dispersions which have a high content of polyolefins, in particular of olefin copolymers and/or of hydrogenated block copolymers.

Furthermore, the polymer dispersions should be capable of being prepared easily and economically, it being intended in particular to use commercially available components. The production should be capable of being carried out on an industrial scale without new plants or plants of complicated design being required for this purpose.

These and further objects which are not explicitly mentioned but which can be readily derived are concluded from the relationships discussed herein at the outset are achieved by polymer dispersions having all the features of Patent claim 1. Expedient modifications of the polymer dispersions according to the invention are protected in the subclaims relating back to claim 1. Regarding the process for the preparation of polymer dispersions, claim 18 provides an achievement of the underlying object, while claim 19 protects a preferred use of a polymer dispersions [sic] of the present invention.

Because polymer dispersions comprise
A) at least one dispersed polyolefin,
B) at least one dispersing component,
C) at least one carrier medium and
D) at least one compound which has a dielectric constant of greater than or equal to 9,
   it is possible to provide, in a manner not directly foreseeable, polymer dispersions which have particularly low viscosity.

At the same time, a number of further advantages can be achieved by the polymer dispersions according to the invention. These include inter alia:
The polymer dispersions according to the invention may comprise particularly large amounts of polyolefins which have a viscosity index-improving or, in lubricating oils, a thickening effect.
The polymer dispersions of the present invention can be adjusted in a particularly simple manner to a predetermined viscosity.
The preparation of the polymer dispersions of the present invention can be prepared [sic] in a particularly easy and simple manner. Customary, industrial plants can be used for this purpose.
   The Component A)

The polymer dispersion comprises, as a component essential to the invention, polyolefins which preferably have a viscosity index-improving or thickening effect. Such polyolefins have long been known and are described in the documents mentioned in the prior art.

These polyolefins include in particular polyolefin copolymers (OCP) and hydrogenated styrene/diene copolymers (HSD).

The polyolefin copolymers (OCP) to be used according to the invention are known per se. They are primarily polymers synthesized from ethylene-, propylene-, isoprene-, butylene-[sic] and/or further -olefins [sic] having 5 to 20 C atoms, as are already recommended as VI improvers. Systems which have been grafted with small amounts of oxygen- or nitrogen-containing monomers (e.g. from 0.05 to 5% by weight of maleic anhydride) may also be used. The copolymers which contain diene components are generally hydrogenated in order to reduce the oxidation sensitivity and the crosslinking tendency of the viscosity index improvers.

The molecular weight Mw is in general from 10 000 to 300 000, preferably between 50 000 and 150 000. Such olefin copolymers are described, for example, in the German Laid-Open Applications DE-A 16 44 941, DE-A 17 69 834, DE-A 19 39 037, DE-A 19 63 039 and DE-A 20 59 981.

Ethylene/propylene copolymers are particularly useful and terpolymers having the known ternary components, such as ethylidene-norbornene (cf. Macromolecular Reviews, Vol. 10 (1975)) are also possible, but their tendency to crosslink must also be taken into account in the aging process. The distribution may be substantially random, but sequential polymers comprising ethylene blocks can also advantageously be used. The ratio of the monomers ethylene/propylene is variable within certain limits, which can be set to about 75% for ethylene and about 80% for propylene as an upper limit. Owing to its reduced tendency to dissolve in oil, polypropylene is less suitable than ethylene/propylene copolymers. In addition to polymers having a predominantly atactic propylene incorporation, those having a more pronounced isotactic or syndiotactic propylene incorporation may also be used.

Such products are commercially available, for example under the trade names Dutral® CO 034, Dutral® CO 038, Dutral® CO 043, Dutral® CO 058, Buna® EPG 2050 or Buna® EPG 5050.

The hydrogenated styrene/diene copolymers (HSD) are likewise known, these polymers being described, for example, in DE 21 56 122. They are in general hydrogenated isoprene/styrene or butadiene/styrene copolymers. The ratio of diene to styrene is preferably in the range from 2:1 to 1:2, particularly preferably about 55:45. The molecular weight Mw is in general from 10 000 to 300 000, preferably between 50 00 and 150 000. According to a particular aspect of the present invention, the proportion of double bonds after the hydrogenation is not more than 15%, particularly preferably not more than 5%, based on the number of double bonds before the hydrogenation.

Hydrogenated styrene/diene copolymers can be commercially obtained under the trade name ®SHELLVIS 50, 150, 200, 250 or 260.

In general, the amount of components A) is at least 20% by weight, preferably at least 30% by weight and particularly preferably at least 40% by weight, without there being any intention to impose a restriction hereby.

The Component B)

The component B) is formed from at least one dispersing component, it being possible for this component frequently to be regarded as block copolymers. Preferably, at least one of these blocks has high compatibility with the previously described polyolefins of components A), at least one further block of the blocks contained in the dispersing components having only low compatibility with the previously described polyolefins. Such dispersing components are known per se, preferred compounds being described in the abovementioned prior art.

The radical compatible with components A) generally has a nonpolar character whereas the incompatible radical is of a polar nature. According to a particular aspect of the present invention, preferred dispersing components may be considered as block copolymers which comprise one or more blocks A and one or more blocks X, the block A representing olefin copolymer sequences, hydrogenated polyisoprene sequences, hydrogenated copolymers of butadiene/isoprene or hydrogenated copolymers of butadiene/isoprene and styrene and the block X representing polyacrylate-, polymethacrylate-, styrene-, α-methylstyrene or N-vinyl-heterocyclic sequences or sequences comprising mixtures of polyacrylate-, polymethacrylate-, styrene-, α-methylstyrene or N-vinyl-heterocycles.

Preferred dispersing components can be prepared by graft polymerization, polar monomers being grafted onto the polyolefins described above, in particular onto the OCP and HSD. For this purpose, the polyolefins can be pretreated by mechanical and/or thermal degradation.

The polar monomers include in particular (meth)acrylates and styrene compounds.

The expression (meth)acrylates includes methacrylates and acrylates and mixtures of the two.

According to a particular aspect of the present invention, a monomer composition comprising one or more (meth)acrylates of the formula (I) 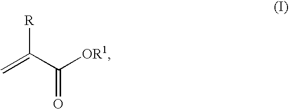
in which R denotes hydrogen or methyl and R¹ denotes hydrogen or a linear or branched alkyl radical having 1 to 40 carbon atoms, is used in the grafting reaction.

The preferred monomers according to formula (I) include, inter alia, (meth)acrylates which are derived from saturated alcohols, such as methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate, hexyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate; (meth)acrylates which are derived from unsaturated alcohols, such as, for example, 2-propynyl (meth)acrylate, allyl (meth)acrylate, vinyl (meth)acrylate, oleyl (meth)acrylate; cycloalkyl (meth)acrylates, such as cyclopentyl (meth)acrylate, 3-vinylcyclohexyl (meth)acrylate, cyclohexyl (meth)acrylate, bornyl (meth)acrylate.

Furthermore, the monomer composition may comprise one or more (meth)acrylates of the formula (II) 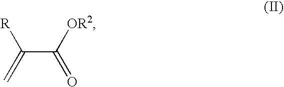
in which R denotes hydrogen or methyl and R² denotes an alkyl radical substituted by an OH group and having 2 to 20 carbon atoms or denotes an alkoxylated radical of the formula (III) 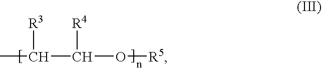
in which R³ and R⁴ independently represent hydrogen or methyl, R⁵ represents hydrogen or an alkyl radical having 1 to 40 carbon atoms and n represents an integer from 1 to 90. [sic]

(Meth)acrylates according to formula (III) are known to a person skilled in the art. These include, inter alia, hydroxyalkyl (meth)acrylates, such as 3-hydroxypropyl methacrylate, 3,4-dihydroxybutyl methacrylate, 2-hydroxyethyl methacrylate, 2-hydroxypropyl methacrylate, 2,5-dimethyl-1,6-hexanediol (meth)acrylate, 1,10-decanediol (meth)acrylate, 1,2-propanediol (meth)acrylate; polyoxyethylene and polyoxypropylene derivatives of (meth)acrylic acid, such as triethylene glycol (meth)acrylate, tetraethylene glycol (meth)acrylate and tetrapropylene glycol (meth)acrylate.

The (meth)acrylates having a long-chain alcohol radical can be obtained, for example, by reacting the corresponding acids and/or short-chain (meth)acrylates, in particular methyl (meth)acrylate or ethyl (meth)acrylate, with long-chain fatty alcohols, in general a mixture of esters, such as, for example, (meth)acrylates having different long-chain alcohol radicals, being formed. These fatty alcohols include, inter alia, Oxo AlcoholÒ 7911 and Oxo AlcoholÒ 7900, Oxo AlcoholÒ 1100 from Monsanto; AlphanolÒ 79 from ICI; NafolÒ 1620, AlfolÒ 610 and AlfolÒ 810 from Condea; EpalÒ 610 and EpalÒ 810 from Ethyl Corporation; LinevolÒ 79, LinevolÒ 911 and DobanolÒ 25L from Shell AG; Lial 125 from AugustaÒ Milan; DehydadÒ and LorolÒ from Henkel KGaA and LinopolÒ 7-11 and AcropolÒ 91 Ugine Kuhlmann [sic].
and/or [sic] one or more (meth)acrylates of the formula (IV) 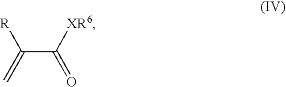
in which R denotes hydrogen or methyl, X denotes oxygen or an amino group of the formula —NH— or -NR⁷-, in which R⁷ represents an alkyl radical having 1 to 40 carbon atoms, and R⁶ denotes a linear or branched alkyl radical substituted by at least one -NR⁸R⁹ group and having 2 to 20, preferably 2 to 6, carbon atoms, R⁸ and R⁹, independently of one another, representing hydrogen or an alkyl radical having 1 to 20, preferably 1 to 6 [lacuna], or in which R⁸ and R⁹, including the nitrogen atom and optionally a further nitrogen or oxygen atom, forming a 5- or 6-membered ring which optionally may be substituted by C₁-C₆-alkyl.

The (meth)acrylates or the (meth)acrylamides according to formula (IV) include, inter alia, amides of (meth)acrylic acid, such as N-(3-dimethylaminopropyl)methacrylamide, N-(diethylphosphono)methacrylamide, 1-methacryloylamido-2-methyl-2-propanol, N-(3-dibutylaminopropyl)methacrylamide, N-tert-butyl-N-(diethylphosphono)methacrylamide, N,N-bis(2-diethylaminoethyl)methacrylamide, 4-methacryloylamido-4-methyl-2-pentanol, N-(methoxymethyl)methacrylamide, N-(2-hydroxyethyl)methacrylamide, N-acetylmethacrylamide,
N-(dimethylaminoethyl)methacrylamide, N-methyl-N-phenylmethacrylamide, N,N-diethylmethacrylamide, N-methylmethacrylamide, N,N-dimethylmethacrylamide, N-isopropylmethacrylamide;
aminoalkyl methacrylates, such as tris(2-methyacryloyloxyethyl)amine, N-methylformamidoethyl methacrylate, 2-ureidoethyl methacrylate;
heterocyclic (meth)acrylates, such as 2-(1-imidazolyl)-ethyl (meth)acrylate, 2-(4-morpholinyl)ethyl-(meth)acrylate and 1-(2-methacryloyloxyethyl)-2-pyrrolidone.

Furthermore, the monomer composition may comprise styrene compounds. These include, inter alia, styrene, substituted styrenes having an alkyl substituent in the side chain, such as, for example, α-methylstyrene and α-ethylstyrene, substituted styrenes having an alkyl substituent on the ring, such as vinyltoluene and p-methylstyrene, halogenated styrenes, such as, for example, monochlorostyrenes, dichlorostyrenes, tribromostyrenes and tetrabromostyrenes.

In addition, the monomer compositions may comprise heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles.

In addition to styrene compounds and (meth)acrylates, particularly preferred monomers are monomers which have dispersing effects, such as, for example, the abovementioned heterocyclic vinyl compounds. These monomers are furthermore designated as dispersing monomers.

The abovementioned ethylenically unsaturated monomers may be used individually or as mixtures. It is furthermore possible to vary the monomer composition during the polymerization so as to obtain defined structures, such as, for example, block copolymers.

The weight ratio of the parts of the dispersing component which are compatible with the polyolefins, in particular of the blocks A, to the parts of the dispersing component which are incompatible with the polyolefins, in particular the blocks X, may be within wide ranges. In general, this ratio is in the range from 50:1 to 1:50, in particular from 20:1 to 1:20 and particularly preferably from 10:1 to 1:10.

The preparation of the dispersing components described above is known to those skilled in the art. For example, the preparation can be effected via a polymerization in solution. Such processes are described, inter alia, in DE-A 12 35 491, BE-A 592 880, U.S. Pat. No. 4,281,081, U.S. Pat. No. 4,338,418 and U.S. Pat. No. 4,290,025.

For this purpose, a mixture of the OCP and one or more of the monomers described above can be initially introduced into a suitable reaction vessel, expediently equipped with stirrer, thermometer, reflux condenser and metering line.

After dissolution under an inert atmosphere, such as, for example, nitrogen, with heating, for example to 110° C., a proportion of a customary free radical initiator, for example from the group consisting of the peresters, is prepared, initially, for example, about 0.7% by weight, based on the monomers.

Thereafter, a mixture of the remaining monomers is metered over a few hours, for example 3.5 hours, with addition of further initator [sic], for example about 1.3% by weight, based on the monomers. A little more initiator is expediently fed sometime after the end of the addition, for example after two hours. The total duration of the polymerization can be taken as a guide value, for example with about 8 hours [sic]. After the end of the polymerization, dilution is expediently effected with a suitable solvent, such as, for example, a phthalic ester, such as dibutyl phthalate. As a rule, a virtually clear, viscous solution is obtained.

Furthermore, the preparation of the polymer dispersion can be effected in a kneader, an extruder or a static mixer. As a result of the treatment in the apparatus, a decrease in the molecular weight of the polyolefin, in particular of the OCP or HSD, occurs under the influence of the shear forces, of the temperature and of the initiator concentration.

Examples of initiators suitable for the graft copolymerization are cumyl hydroperoxide, diumyl [sic] peroxide, benzoyl peroxide, azobisisobutyronitrile, 2,2-bis(tert-butylperoxy)butane, diethyl peroxy-dicarbonate and tert-butyl peroxide. The processing temperature is between 80° C. and 350° C. The residence time in the kneader or extruder is between 1 minute and 10 hours.

The longer the dispersion is treated in the kneader or extruder, the lower will be the molecular weight. The temperature and the concentration of free radical initiators can be adjusted according to the desired molecular weight. By incorporation into suitable carrier media, the solvent-free polymer-in-polymer dispersion can be converted into a liquid polymer/polymer emulsion which is easy to handle.

The amount of components B) is in general up to 30% by weight, and in particular this amount is in the range from 5 to 15% by weight, without there being any intention to impose a restriction hereby. The use of larger amounts of component B) is frequently uneconomical. Smaller amounts often lead to lower stability of the polymer dispersion.

The Component C)

The component C) is essential for the success of the present invention. The solvents which can be used as liquid carrier medium should be inert and as a whole safe. Carrier media which fulfils said condition belong, for example, to the group consisting of the esters and ethers and/or to the group consisting of the higher alcohols. As a rule, the molecules of the types of compound which are suitable as carrier medium contain more than 8 carbon atoms per molecule.

It should be mentioned that mixtures of the solvents described above are also suitable for the carrier medium.

The following should be singled out in the group consisting of the esters: phosphoric esters, esters of dicarboxylic acids, esters of monocarboxylic acids with diols or polyalkylene glycols, esters of neopentylpolyols with monocarboxylic acids (cf. Ullmanns Encyclopädie der Technischen Chemie [Ullmann's Encyclopaedia of Industrial Chemistry], 3rd edition, Vol. 15, pages 287-292, Urban and Schwarzenber [sic] (1964)). Suitable esters of dicarboxylic acids, are the esters of phthalic acid, in particular the phthalic esters with C₄ to C₈ alcohols, dibutyl phthalate and dioctyl phthalate being mentioned in particular, and also the esters of aliphatic dicarboxylic acids, in particular the esters of straight-chain dicarboxylic acids with branched primary alcohols. The esters of sebacic, of adipic and of azelaic acid are particularly singled out and in particular the 2-ethylhexyl and isooctyl-3,5,5-trimethyl esters and the esters with the C₈-, C₉- or C₁₀-oxo alcohols should be mentioned.

The esters of straight-chain primary alcohols with branched dicarboxylic acids are particularly important. Alkyl-substituted adipic acid, for example 2,2,4-trimethyladipic acid may be mentioned as examples.

Advantageous alcohol components are, for example, the abovementioned oxo alcohols. The diesters with diethylene glycol, triethylene glycol, tetraethylene glycol to decamethylene glycol, and furthermore with dipropylene glycol, as alcohol component may be singled out as esters of monocarboxylic acids with diols or polyalkylene glycols. Propionic acid, (iso)butyric acid and pelargonic acid being mentioned specifically as monocarboxylic acids—for example dipropylene glycol perlargonate, diethylene glycol dipropionate and diisobutyrate and the corresponding esters of triethylene glycol and tetraethylene glycol di-2-ethylhexanoate may be mentioned.

Preferred carrier media are nonionic surfactants. These include, inter alia, fatty acid polyglycol esters, fatty amine polyglycol ethers, alkylpolyglycosides, fatty amine N-oxides and long-chain alkyl sulphoxides. Furthermore, the abovementioned esters having ethoxy groups belong to the group consisting of the nonionic surfactants.

A further group with particularly preferred carrier media which are nonionic surfactants are alcohols etherified with (oligo)oxyalkyl groups.

These include in particular ethoxylated alcohols which particularly preferably have from 1 to 20, in particular 2 to 8, ethoxy groups. The hydrophobic radical of the ethoxylated alcohols comprises preferably from 1 to 40, especially from 4 to 22, carbon atoms, it being possible to use both linear and branched alcohol radicals. Oxo alcohol ethoxylates may also be used.

Examples of commercial ethoxylates which can be used for the preparation of the concentrates according to the invention are ethers of Lutensol® A grades, in particular Lutensol® A 3 N, Lutensol® A 4 N, Lutensol® A 7 N and Lutensol® A 8 N, ethers of Lutensol® TO grades, in particular Lutensol® TO 2, Lutensol® TO 3, Lutensol® TO 5, Lutensol® TO 6, Lutensol® TO 65, Lutensol® TO 69, Lutensol® TO 7, Lutensol® TO 79, Lutensol® 8 and Lutensol® 89, ethers of Lutensol® AO grades, in particular Lutensol® AO 3, Lutensol® AO 4, Lutensol® AO 5, Lutensol® AO 6, Lutensol® AO 7, Lutensol® AO 79, Lutensol® AO 8 and Lutensol® AO 89, ethers of Lutensol® ON grades, in particular Lutensol® ON 30, Lutensol® ON 50, Lutensol® ON 60, Lutensol® ON 65, Lutensol® ON 66, Lutensol® ON 70, Lutensol® ON 79 and Lutensol® ON 80, ethers of Lutensol® XL grades, in particular Lutensol® XL 300, Lutensol® XL 400, Lutensol® XL 500, Lutensol® XL 600, Lutensol® XL 700, Lutensol® XL 800, Lutensol® XL 900 and Lutensol® XL 1000, ethers of Lutensol® AP grades, in particular Lutensol® AP 6, Lutensol® AP 7, Lutensol® AP 8, Lutensol® AP 9, Lutensol® AP 10, Lutensol® AP 14 and Lutensol® AP 20, ethers of IMBENTIN® grades, in particular of IMBENTIN® AG grades, of IMBENTIN®U grades, of IMBENTIN® C grades, of IMBENTIN® grades, of IMBENTIN® OA grades, of IMBENTIN® POA grades, of IMBENTIN® N grades and of IMBENTIN® O grades and ethers of Marlipal® grades, in particular Marlipal® 1/7, Marlipal® 1012/6, Marlipal® 1618/1, Marlipal® 24/20, Marlipal® 24/30, Marlipal® 24/40, Marlipal® 013/20, Marlipal® 013/30, Marlipal® 013/40, Marlipal® 025/30, Marlipal® 025/70, Marlipal® 045/30, Marlipal® 045/40, Marlipal® 045/50, Marlipal® 045/70 and Marlipal® 045/80.

In particular, mixtures which comprise alcohols etherified with (oligo)oxyalkyl groups and esters are particularly preferred. Such mixtures have an unexpectedly high stability. This applies in particular to dispersions which comprise hydrogenated styrenediene copolymers (HSD). Here, the weight ratio of ester to an alcohol etherified with (oligo)oxyalkyl groups may be within wide ranges. Particularly preferably, this ratio is in the range from 15:1 to 1:15, in particular from 5:1 to 1:5.

A further group of preferred carrier media are mineral oils. Surprisingly, it was found that the stability of the polymer dispersion can be considerably increased by the presence of mineral oil.

Mineral oils are known per se and are commercially available. They are obtained in general from petroleum or crude oil by distillation and/or refining and optionally further purification and treatment processes, the term mineral oil covering in particular the relatively high-boiling fractions of crude oil or petroleum. In general, the boiling point of mineral oil is higher than 200° C., preferably higher than 300° C., at 5 000 Pa. The production by low-temperature carbonization of shale oil, coking of hard coal, distillation of lignite in the absence of air and hydrogenation of hard coal or lignite is likewise possible. To a small extent, mineral oils are also produced from raw materials of vegetable (e.g. from jojoba, rape) or animal (e.g. neatsfoot oil) origin. Accordingly, mineral oils have different fractions of aromatic, cyclic, branched and linear hydrocarbons, depending on origin.

In general, a distinction is made between paraffin-based, naphthenic and aromatic fractions in crude oils or mineral oils, the terms paraffin-based fraction representing relatively long-chain and highly branched isoalkanes and naphthenic fraction representing cycloalkanes. In addition, depending on origin and treatment, mineral oils have different proportions of n-alkanes, isoalkanes having a low degree of branching, so-called monomethyl-branched paraffins, and compounds having heteroatoms, in particular O, N and/or S, to which to a certain extent polar properties are attributed. However, the assignment is difficult since individual alkane molecules may have both long-chain branched groups and cycloalkane radicals and aromatic moieties. For the purposes of the present invention, the assignment can be made, for example, according to DIN 51 378. Polar moieties can also be determined according to ASTM D 2007.

The proportion of the n-alkanes in preferred mineral oils is less than 3% by weight, in the proportion of O, N and/or S-containing compounds less than 6% by weight. The proportion of aromatics and of monomethyl-branched paraffins is in general in each case in the range from 0 to 40% by weight. According to an interesting aspect, mineral oil mainly comprises naphthenic and paraffin-based alkanes, which in general have more than 13, preferably more than 18 and very particularly preferably more than 20, carbon atoms. The proportion of these compounds is in general ≧60% by weight, preferably ≧80% by weight, without it being intended to impose any restriction hereby. A preferred mineral oil contains from 0.5 to 30% by weight of aromatic fractions, from 15 to 40% by weight of naphthenic fractions, from 35 to 80% by weight of paraffin-based fractions, up to 3% by weight of n-alkanes and from 0.05 to 5% by weight of polar compounds, based in each case on the total weight of the mineral oil.

An analysis of particularly preferred mineral oils which was effected by means of conventional methods, such as urea separation and liquid chromatography over silica gel, indicates, for example, the following components, the stated percentages being based on the total weight of the mineral oil used in each case:
n-alkanes having about 18 to 31 C atoms:
0.7-1.0%,
alkanes having 18 to 31 C atoms and a low degree of branching:
1.0-8.0%,
aromatics having 14 to 32 C atoms:
0.4-10.7%,
iso- and cycloalkanes having 20 to 32 C atoms:
60.7-82.4%,
polar compounds:
0.1-0.8%,
loss:
6.9-19.4%.

Valuable information regarding the analysis of mineral oils and a list of mineral oils which have a differing composition is to be found, for example, in Ullmanns Encyclopedia of Industrial Chemistry, 5^{th} edition on CD-ROM, 1997, key word “lubricants and related products”.

According to a particular aspect of the present invention, mixtures which comprise mineral oil and nonionic surfactants, in particular alcohols etherified with (olio)oxyalkyl groups, are used as carrier medium.

Such mixtures have an unexpectedly high stability. Here, the weight ratio of mineral oil to nonionic surfactant, in particular alcohol etherified with (oligo)oxyalkyl groups may be within wide ranges. Particularly preferably, this ratio is in the range from 15:1 to 1:15, in particular from 5:1 to 1:5.

The amount of the carrier medium as a proportion of the concentrated polymer dispersion may be within wide ranges this amount being dependent in particular on the polyolefins and dispersing components used. In general, the amount of the carrier medium is from 79 to 25% by weight, preferably less than 70, especially from 60 to 40, % by weight, based on the total polymer dispersion.

The Component D)

The component D) is obligatory for the present polymer dispersion, this component comprising one or more compounds having a dielectric constant of greater than or equal to 9, particularly less than or equal to 20 and particularly preferably greater than or equal to 30.

The dielectric constant can be determined by methods stated in Handbook of Chemistry and Physics, David R. Lide, 79th Edition, CRS Press, the dielectric constant being measured at 20° C.

The particularly suitable compounds include, inter alia, water, glycols, in particular ethylene glycol, 1,2-propylene glycol, 1,3-propylene glycol, polyethylene glycol; alcohols, in particular methanol, ethanol, butanol, glycerol; ethoxylated alcohols, for example diethoxylated butanol, decaethoxylated methanol; amines, in particular ethanolamine, 1,2 ethanediamine [sic] and propanolamine; halogenated hydrocarbons, in particular 2-chloroethanol, 1,2 dichloroethane [sic], 1,1 dichloroacetone [sic]; ketones, in particular acetone.

The amount of components D) in the polymer dispersion may be within wide ranges. In general, the polymer dispersion comprises 0.01-15% by weight, in particular from 0.3 to 5% by weight, of compounds according to component D).

In addition to the abovementioned components, the polymer dispersion according to the invention may contain further additives and added substances.

The polymer dispersions can be prepared by known processes, these processes being described in the abovementioned documents of the prior art. Thus, for example, the present polymer dispersions can be prepared by dispersing component A) in a solution of components B) with application of shear forces at a temperature in the range of from 80 to 180° C. The solution of components B) comprises in general component C). Component D) can be added to the dispersion before, during or after the dispersing of components A).

The invention is explained in more detail below by examples and comparative examples, without it being intended to restrict the invention to these examples.

Methods Used

Below, KV100 means the kinematic viscosity of a liquid, measured at 100° C. in a 150N oil. The determination of the viscosity is carried out according to DIN 51 562 (Ubbelohde viscometer). Here, the concentration of the OCP in oil is in each case 2.8% by weight. The data BV20, BV40 and BV100 designate the kinematic viscosities of the dispersions (BV=“bulk viscosity”), likewise measured according to DIN 51 562 (Ubbelohde viscometer) at 20, 40 and 100° C., respectively.

In the case of the addition of water to the dispersion, distilled water was used. Ethylene glycol used was ethylene glycol for analysis (Merck), and polyethylene glycol used was polyethylene glycol 400 for synthesis (Merck-Schuchardt).

The addition of the last component of hydrophilic character, 0.5 or 1.0% by weight was added to the respective dispersion heated to 90 to 110° C. in a 1 1 glass bottle and the resulting still warm mixture in the glass bottle was homogenized on a roller stand (speed: 160 rpm) for a period of from half an hour to one hour. BV20, BV40 and BV100 values were determined in each case before and after the addition of the hydrophilic component.

Initiators used for the preparation of the dispersions were conventional members, such as, for example, the per initiators di(tert-butylperoxy)-3,3,5-trimethyl-cyclohexane and/or tert-butyl peroctanoate.

For testing the stability of a dispersion, 670 g of the product can be weighed into a 2 litre Witt pot. An Inter-Mig stirrer having three paddles (measuring stirrer with torque and speed indication MR-D1 from Ika) and an NiCrNi thermocouple (temperature controller 810 from Eurotherm) are installed in the Witt pot. The oil bath (silicone oil PN 200) is heated up, the speed being adjusted so that a power of 3.1 watt is introduced. The power introduced can be calculated via the viscosity.

The product is heated to 160° C. and this internal temperature is then maintained for 2 h. Thereafter, the internal temperature in the reactor is increased by 10° C. in the course of 15 minutes and once again maintained for 2 h, this procedure being repeated several times until the internal temperature is 190° C. If the product undergoes phase separation beforehand, which is evident from an abrupt increase in the viscosity and hence from a rapid increase in the torque, the experiment is terminated. The time and temperature at this point in time are detected.

### EXAMPLE 1

In a 2 litre four-necked flask equipped with stirrer, thermometer and reflux condenser, 63.8 g of a styrene/diene copolymer (e.g. SHELLVIS® 260) are dissolved in 271.3 g of an ester (e.g. Vestinol® OA) and 90.4 g of an ethoxylated fatty alcohol (e.g. Marlipal® O13/20) at 100° C. in the course of 3-4 hours. After the dissolution process, 47.3 g of a C12-C16-alkyl methacrylate are added and inert conditions are created by adding dry ice. The temperature is again adjusted to 100° C., after which 1.14 g of tert-butyl peroctanoate are added and at the same time a feed consisting of a mixture of 527.2 g of the C12-C16 alkyl methacrylate and 6.33 g of tert-butyl peroctanoate is started. The feed time is 3.5 hours. The feed rate is constant. 2 hours after the end of the feed, a further 1.15 g g [sic] of tert-butyl peroctanoate are added. 134.2 g of the prepared solution together with 196.8 g of the styrene/diene copolymer (e.g. SHELLVIS® 260) and 169.0 g of the ethoxylated fatty alcohol (e.g. Marlipal® O13/20) are weighed into a 1 litre Witt pot having an Inter-Mig stirrer (ratio of stirrer/container diameter=0.7; stirrer speed to be set: 200 rpm). A dispersion forms in the course of 8-10 hours at 100° C. and a stirrer speed of 200 rpm. The actual viscosity of this highly concentrated Shellvis 260 dispersion is about 4 084 mm²/s at 40° C. and about 4 933 mm²/s at 100° C.

Addition of 0.5 or 1.0% by weight of the following substances according to the process described at the outset leads to the viscosity values stated below:

| | | BV40 | BV100 |
|---|---|---|---|
| Compound added | Amount added | [mm²/s] | [mm²/s] |
| — | N/A | 4 084 | 4 933 |
| Distilled water | 0.5% by weight | 3 038 | 1 907 |
| Distilled water | 1.0% by weight | 2 533 | 1 041 |
| Ethylene glycol | 1.0% by weight | 2 616 | 1 229 |
| Polyethylene glycol | 1.0% by weight | 2 926 | 1 670 |

### EXAMPLE 2

In a 2 litre four-necked flask equipped with a stirrer, thermometer and reflux condenser, 70.3 g of an ethylene/propylene copolymer having a thickening effect of 11.0 mm²/S with respect to KV100 (e.g. thermally or mechanically degraded Dutral® CO 038) are weighed into a mixture consisting of 251.8 g of a 150N oil and 47.9 g of a 100N oil and dissolved in 100° C. in the course of 10-12 hours. After the dissolution process, 41.1 g of a mixture consisting of alkyl methacrylates having alkyl substituents of chain length C10-C18 are added and the reaction mixture is rendered inert by adding dry ice. After the polymerization temperature of 130° C. has been reached 0.52 g of 1,1-di(tert-butylperoxy)-3,3,5-trimethylcyclohexane is added and at the same time a monomer feed consisting of 588.9 g of a composition analogous to the above and 7.66 g of 1,1-di(tertbutylperoxy)-3,3,5-trimethylcyclohexane is started and added uniformly over a feed time of 3.5 hours. 2 hours after the end of the feed, dilution to a polymer content of 47.55% is effected with 472.1 g of an ethoxylated fatty alcohol (e.g. Marlipal® O13/20). At the same time, the temperature is reduced to 100° C., 1.26 g of tert-butyl peroctanoate are added and stirring is carried out for a further 2 hours at 100° C. 286.2 g of the prepared solution, 43.2 g of an ethylene/propylene copolymer (e.g. Dutral® Co 038, degraded to 11.5 mm²/s) and 170.6 g of a further ethylene/propylene copolymer (e.g. Dutral® CO 058 degraded to a KV100 of 11.5 μm²/s) are weighed into 1 litre of a Witt pot equipped with an Inter-Mig stirrer (ratio of stirrer/container diameter=0.7; stirrer speed set: 150 rpm). A brownish dispersion forms in the course of 8-10 hours at 100° C. and a stirrer speed of 150 rpm, which dispersion still tends to separate out the ethylene/propylene copolymer within a few weeks and at room temperature. For stabilization, the temperature is therefore increased from 100° C. to 140° C. as stirring is continued at 150 rpm for 6 hours. Dilution to a polymer content of 55% is then effected by dilution with 136.6 g of an ethoxylated fatty alcohol (e.g. Marlipal® O13/20) and the mixture is stirred for a further half hour at 100° C. The polymer content of the dispersion is then reduced to 52% by weight by further addition of Marlipal® O13/20. The BV40 of a dispersion thus prepared was 3 834 mm²/s and the BV100 was 1 623 mm²/s. The addition of 1.0% by weight of water according to the process described above led to a decrease in the BV40 to 3 169 mm²/s and to a reduction in the BV100 to 801 mm²/s.

### EXAMPLE 3

The preparation of the OCP dispersion is carried out analogously to Example 2, except that dioctyl adipate (e.g. Vestinol OA) is used instead of mineral oil and that the last dilution step from 55 to 52% by weight polymer content is not carried out. The KV100 of the solution of 2.8% by weight of a dispersion thus obtained in a 150N oil was measured as 10.85 mm²/s. The BV40 was 3 844 mm²/s and the BV100 was 1 499 mm²/s. Addition of 1.0% by weight of water to the dispersion resulted in no change in the KV100 but was associated with a reduction in the BV to 2 725 mm²/s and a decrease in the BV100 to 746 mm²/s.

### EXAMPLE 4

A dispersion prepared analogously to Example 2 had a BV20 of 3 450 mm²/s . The addition of 4.5% by weight of diethoxylated butanol led to a reduction in the BV20 to 2 880 mm²/s.

1. A polymer dispersion having low viscosity comprising
A) at least one dispersed polyolefin,
B) at least one dispersing component,
C) at least one carrier medium and
D) at least one compound having a dielectric constant of greater than or equal to 9,
said compound being water, a glycol, an amine, a halogenated hydrocarbon, a ketone and/or an alcohol.

2. The polymer dispersion according to claim 1, wherein the component B) represents a copolymer which comprises one or more blocks A and one or more blocks X, the block A representing olefin copolymer sequences, hydrogenated polyisoprene sequences, hydrogenated copolymers of butadiene/isoprene or hydrogenated copolymers of butadiene/isoprene and styrene, and the block X representing polyacrylate-, polymethacrylate-, styrene-, α-methylstyrene or N-vinyl-heterocyclic sequences and/or sequences of mixtures of polyacrylate-, polymethacrylate-, styrene-, α-methylstyrene or N-vinyl-heterocycles.

3. The polymer dispersion according to claim 1, wherein the component B) is obtained by graft copolymerization of a monomer composition comprising (meth)acrylates and/or styrene compounds onto polyolefins according to component A).

4. The polymer dispersion according to claim 3, wherein said monomer composition comprises one or more (meth)acrylates of the formula (I) 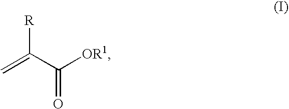
wherein R denotes hydrogen or methyl and R¹ denotes hydrogen or a linear or branched alkyl radical having 1 to 40 carbon atoms,
and/or one or more (meth)acrylates of the formula (II) 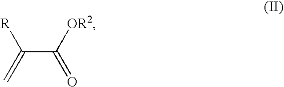
wherein R denotes hydrogen or methyl and R² denotes an alkyl radical substituted by an OH group having 2 to 20 carbon atoms or denotes an alkoxylated radical of the formula (III) 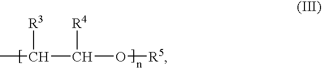
wherein R³ and R⁴ independently represent hydrogen or methyl, R⁵ represents hydrogen or an alkyl radical having 1 to 40 carbon atoms and n represents an integer from 1 to 90,
and/or one or more (meth)acrylates of the formula (IV) 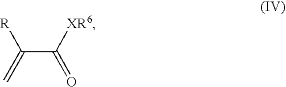
wherein R denotes hydrogen or methyl, X denotes oxygen or an amino group of the formula —NH— or -NR⁷-, in which R⁷ represents an alkyl radical having 1 to 40 carbon atoms, and R⁶ denotes a linear or branched alkyl radical substituted by at least one -NR⁸R⁹ group and having 2 to 20, carbon atoms, R⁸ and R⁹, independently of one another, representing hydrogen, an alkyl radical having from 1 to 20, or in which R⁸ and R⁹, including the nitrogen atom and optionally a further nitrogen or oxygen atom, form a 5- or 6-membered ring which may optionally be substituted by C₁-C₆-alkyl.

5. The polymer dispersion according to claim 3, wherein said monomer composition comprises dispersing monomers.

6. The polymer dispersion according to claim 2, wherein the weight ratio of the blocks A to the blocks X is in the range from 20:1 to 1:20.

7. The polymer dispersion according to claim 1, wherein the component A) comprises one or more olefin copolymers, hydrogenated polyisoprene, hydrogenated copolymers of butadiene/isoprene or hydrogenated copolymers of butadiene/isoprene and styrene.

8. The polymer dispersion according to claim 1, wherein the component C) is a nonionic surfactant.

9. The polymer dispersion according to claim 8, wherein the nonionic surfactant comprises an ethoxylated alcohol.

10. The polymer dispersion according to claim 9, wherein the ethoxylated alcohol comprises from 2 to 8 ethoxy groups, the hydrophobic radical of the alcohol comprising from 4 to 22 carbon atoms.

11. The polymer dispersion according to claim 1, wherein the component C) comprises one or more esters.

12. The polymer dispersion according to claim 1, wherein the polymer dispersion comprises at least 20% by weight of the component A).

13. The polymer dispersion according to claim 1, wherein the dielectric constant of the compound according to component D) is greater than or equal to 20.

14. The polymer dispersion according to claim 1, wherein said component D) comprises water, ethylene glycol, polyethylene glycol and/or alcohol.

15. The polymer dispersion according to claim 1, wherein the polymer dispersion comprises up to 30% by weight of component B).

16. The polymer dispersion according to claim 1, wherein the polymer dispersion comprises 0.01-15% by weight of compounds according to component D).

17. The polymer dispersion according to claim 1, wherein the polymer dispersion comprises a mineral oil.

18. A process for the preparation of said polymer dispersion according to claim 1, wherein the component A) is dispersed in a solution of components B) with application of shear forces at a temperature in the range from 80 to 180° C.

19. (canceled)

20. A lubricating oil formulation comprising the polymer dispersion according to claim 1.
